(19) United States
(12) Patent Application Publication
(10) Pub. No.: US 2008/0273442 A1
(43) Pub. Date: Nov. 6, 2008

(54) Method and Apparatus for Recording Information on a Multi-Layered Optical Disc

(75) Inventors: Robert Albertus Brondijk, Eindhoven (NL); Petrus Jacobus Hubertus Johannes Van Asten, Eindhoven (NL); Wiebe De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,556

(22) PCT Filed: Jun. 1, 2006
(86) PCT No.: PCT/IB06/51751

§ 371 Date: Dec. 5, 2007

(30) Foreign Application Priority Data
Jun. 9, 2005 (EP) 05300471.9

(51) Int. Cl. G11B 7/20

(52) U.S. Cl. 369/94

(57) ABSTRACT

A method is described for recording information on a multi-layered optical disc (2), the disc comprising two storage spaces (LO, L1) in adjacent storage layers (40, 41). Data to be recorded are received from a source. On recording, the data are organized to form cells (35), each cell corresponding to a certain amount of data. The cells are first recorded in the first storage space (LO) until the last storage address (N) of the first storage space, and then the recording process makes a transition to the first storage address (N+1) of the second storage space. The size of the last cell to be recorded in the first storage space is determined in relationship to the size of the remainder part (R) of the first storage space, such that the transition from the first storage space to the second storage space corresponds to a cell boundary (34).

### FIELD OF THE INVENTION

The present invention relates in general to a method for writing information on a multiple-layer optical storage disc, and to a device for executing the method.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs are very successful, and several different types have been developed. One such type is DVD (Digital Versatile Disc), and the present invention relates particularly to DVD discs. However, the gist of the present invention is also applicable to other types of discs; therefore, the following description is not to be understood as limiting the scope of the present invention to DVD discs only.

Optical discs may be read-only type, containing information which can only be read by a user. The optical storage disc may also be a writeable type, where information may be stored by a user. Such discs may be a write-once type, indicated as writable (R), but there are also storage discs where information can be written many times, indicated as rewritable (RW). In the case of DVD, a distinction is made between two formats, i.e. the “minus”-format (DVD-R, DVD-RW) and the “plus”-format (DVD+R, DVD+RW).

For writing information in the storage space of the optical storage disc, a storage track is scanned by an optical write beam, typically a laser beam, of which the intensity is modulated to cause material changes which can later be read out by scanning the storage track by an optical read beam. Since the technology of optical discs in general, and the way in which information can be stored in an optical disc, is commonly known, it is not necessary here to describe this technology in more detail. However, it is noted that a storage track defines a range of storage locations having unique addresses.

Typically, an optical storage system comprises an optical disc as a record medium, and further comprises a disc drive apparatus and a host apparatus. The disc drive apparatus is a device, comprising optical means for actually writing data, capable of accessing all storage blocks where it is physically possible to store information. The unique addresses of all these physical storage locations are indicated as physical addresses. The host apparatus, which may be a PC running a suitable program, or an application of a consumer apparatus such as a video recorder, is a device which communicates with the disc drive, and sends commands to the disc drive instructing the disc drive to write certain data to a certain storage location. In contrast to the disc drive apparatus, the host apparatus only has access to a part of the physical storage space, this part being indicated as logical storage space, and the storage blocks in the logical storage space also have logical storage addresses. Although the logical storage space does not need to be a physically contiguous storage space, the storage blocks in the logical storage space have consecutive logical addresses, which are usually not identical to the physical addresses.

Conventionally, an optical disc has only one storage layer containing a storage track. More recently, optical discs have been developed having two or even more storage layers, each storage layer containing a storage track in the shape of a spiral or multiple concentric circles. In such case, the logical storage space extends over multiple storage layers, hence the range of logical addresses extends contiguously over multiple storage layers. The transition from the last block of one storage layer to the first block of the next storage layer is such that the logical address is incremented only by 1.

The present invention relates particularly to optical discs having two storage layers. However, the gist of the present invention is also applicable to discs having three or more layers; therefore, the following description is not to be understood as limiting the scope of the present invention to double-layered discs only.

It is noted that the present invention relates to optical discs where at least two storage layers are approached by a laser beam from the same side. The disc has a main surface which is directed towards the laser; this main surface will be indicated as entrance surface. For access to a specific storage layer, the laser beam enters the disc at the entrance surface, and travels the depth of the disc until it reaches the specific storage layer. Selection of a specific storage layer involves focussing the laser beam at the corresponding depth. In the following, the storage layer which is located closest to the entrance surface will be indicated as first storage layer, and the corresponding logical space will be indicated as L0; the next storage layer will be indicated as second storage layer, and the corresponding logical space will be indicated as L1. Thus, in the case of a dual layer disc, the entire logical space of the disc will be L0+L1.

In the case of a dual layer disc, the first layer L0 extends from an inner radius to an outer radius. In other words, logical address zero corresponds to a certain physical address (30000) relatively close to the centre of the disc, while increasing logical addresses correspond to increasing track radius, such that the highest logical address corresponds to a radius relatively close to the perimeter of the disc.

For the second layer L1, there are two possibilities. In one possibility, the logical addresses are numbered in the same way as L0, i.e. increasing from the inner track radius to the outer track radius; this arrangement is indicated as Parallel Track Path (PTP). In another possibility, indicated as Opposite Track Path (OTP), the logical addresses are numbered from the outer track radius to the inner track radius.

When a disc is written according to the PTP arrangement, the laser beam scans L0 in a direction from centre to perimeter. After a jump to L1, writing continues at the innermost track of L1, in the same direction from centre to perimeter. In such case, the storage capacity of L1 is independent from the location of the last block of the first track. In an OTP case, however, after a jump from L0 to L1, writing continues at the location of the jump, in the opposite direction from perimeter to centre; in such case, the size of the available logical space in L1 is clearly dependent on the location of the last block of the first track.

The present invention relates specifically to a disc of OTP type, i.e. a disc having at least one pair of successive storage layers with mutually opposite track direction. However, the gist of the present invention is also applicable to a disc of PTP type.

A typical problem occurs in case the information being written is real-time video information. During writing, the host organizes DVD Video data in cells, and a transition from one layer to the next is only allowed at a cell boundary; this is related to the fact that, on reading video data from disc, it is desirable to have seamless continuation of video image display. On the other hand, the disc drive continues writing in L0 until a predefined logical end address is reached; after having written information at the end address, the disc drive jumps to L1 and continues writing at the next logical address in L1 (at the inner radius in a PTP case, or at the radius of the end address of L0 in an OTP case). Usually, this transition from L0 to L1 does not correspond to a video cell boundary. As a result, on playing the recording, display is not seamless: display may show a delay, a freeze-image, or a “hick-up”, or the disc drive may even crash.

It is usually not known in advance where the cell boundaries will be located. The disc drive, receiving the video data from the host, has no means for generating such boundaries when approaching the end of L0 (in fact, the disc drive does normally not even “know” that it is writing video information). On the other hand, the host device is not capable of instructing the disc drive to use a specific physical address, and is not capable of instructing the disc drive to make a transition to L1 before having reached the end of L0 (a transition to L1 can only be made at the end of L0).

An important objective of the present invention is to overcome the above difficulties.

More specifically, an objective of the present invention is to assure that the last logical address of a storage layer corresponds to a video cell boundary, in order to assure seamless image reproduction on reading.

In the above, objectives of the present invention have been explained in the context of video cell boundaries in the case of writing video data. However, it may be desirable for other reasons to organize data in cells, and to have a transition from L0 to L1 correspond to a data cell boundary.

### SUMMARY OF THE INVENTION

According to an important aspect of the present invention, a host has a buffer memory for the data to be sent to the drive. Normally, the host determines the size of a video cell on the basis of certain predefined considerations; the size of said buffer is at least equal to the size of the largest video cell to be expected. In normal operation, the end of L0 is far away and the video data may be streamed to the disc drive. It is noted that the host has information on the end address of L0. On approaching the end of L0, the video data is stored in the buffer memory. If the user issues a stop command before the end address of L0 is reached, the entire contents of the buffer memory is coded as a cell and sent to the disc drive. If the user does not issue a stop command and the data amount in the buffer memory exceeds the remaining storage capacity in L0, the host generates a video cell having a size corresponding to the remaining storage capacity in L0, and this cell is sent to the disc drive.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 is a block diagram schematically illustrating a data storage system;

FIG. 2 is schematical cross-section of a dual-layer optical disc;

FIG. 3 is a diagram schematically depicting a double-track storage space of a storage medium in an OTP case;

FIG. 4 is a diagram schematically illustrating the transition from one storage layer to the next;

FIG. 5A is a flow schedule showing steps of an embodiment of a recording method according to the present invention;

FIG. 5B is a diagram, comparable to FIG. 4, illustrating the effect of the method of FIG. 5A;

FIG. 6A is a flow schedule showing steps of another embodiment of a recording method according to the present invention;

FIG. 6B is a diagram, comparable to FIG. 4, illustrating the effect of the method of FIG. 6A.

### DETAILED DESCRIPTION OF THE INVENTION

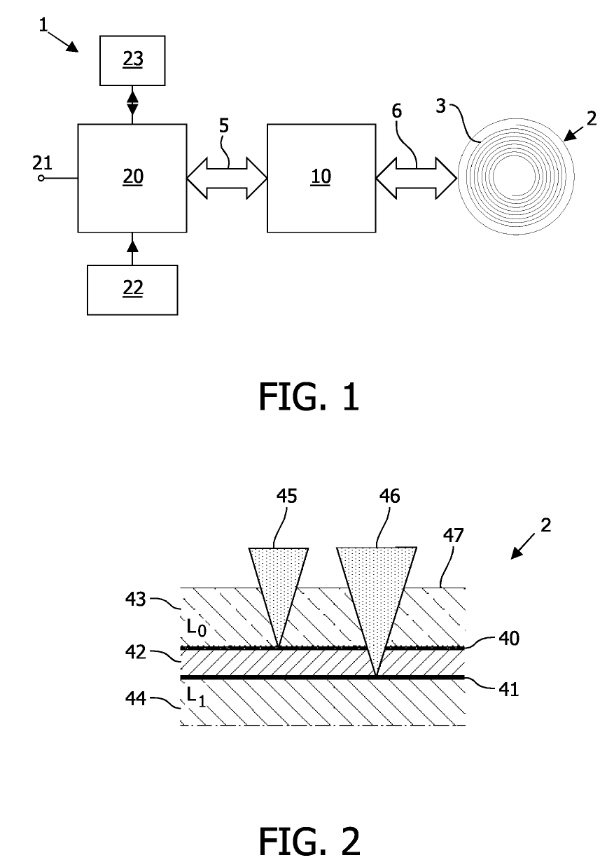

FIG. 1 is a block diagram schematically illustrating a data storage system 1, comprising an optical disc 2, a disc drive device 10, and a host device 20. In a typical practical implementation, the host device 20 may be a suitably programmed personal computer (PC); it is also possible that the data storage system 1 is implemented as a dedicated user apparatus such as a video recorder, in which case the host device 20 is the application part of such apparatus. In a specific embodiment, the optical disc 2 is a DVD, more specifically a DVD-R.

A host/drive communication link between host device 20 and disc drive 10 is indicated at 5. Likewise, a drive/disc communication link between disc drive 10 and disc 2 is indicated at 6. The drive/disc communication link 6 represents the physical (optical) read/write operation as well as the physical addressing of the disc 2. The host/drive communication link 5 represents a data transfer path as well as a command transfer path.

It is noted that disc drives are known, and that the present invention can be implemented using an existing disc drive; therefore, it is not necessary here to describe the design and operation of the disc drive 10 in great detail.

The optical disc 2 has a storage space 3, which has the form of two or more continuous spiral-shaped tracks or tracks in the form of multiple concentric circles, where information can be stored in the form of a data pattern. Since this technology is commonly known to persons skilled in the art, this technology will not be explained in further detail.

The several tracks of the storage space 3 are located in different storage layers of the optical disc 2. FIG. 2 is a schematic cross-section of a portion of the disc 2, showing a first storage layer 40 and a second storage layer 41. Between these two storage layers is a transparent spacer layer 42. An optical beam is illustrated in two conditions, i.e. focussed on the first layer 40 (beam 45) and focussed on the second layer 41 (beam 46). The disc 2 has an entrance surface 47, where the optical beam 45, 46 enters a transparent cover layer 43. The first storage layer 40 is closer to the entrance surface 47 than the second storage layer 41. Reference numeral 44 indicates a substrate of the disc 2.

It is noted that in FIG. 2 the entrance surface 47 is the top surface; depending on the configuration of the disc drive, the entrance surface may also be the lower surface.

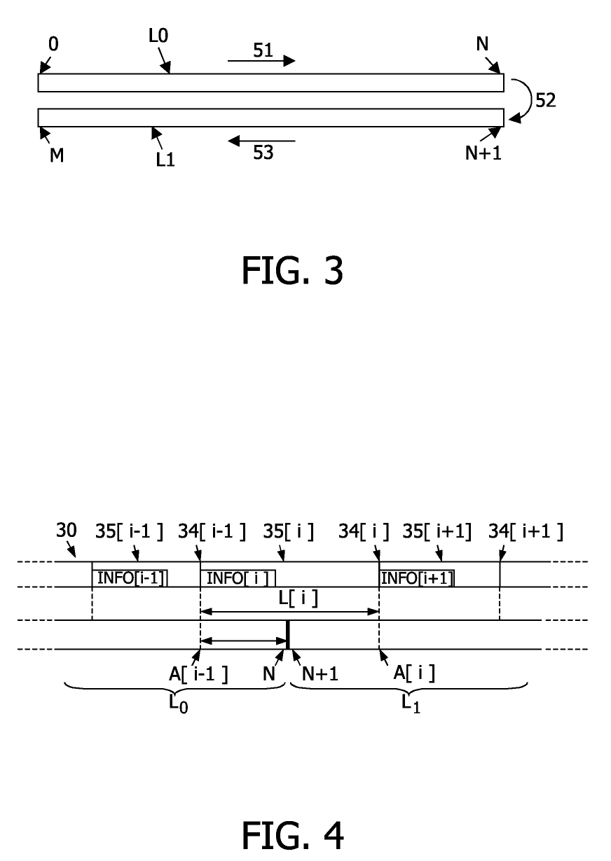

The storage locations in the storage layers 40 and 41 have logical addresses; these logical addresses define a logical space. The logical space of the first storage layer 40 is indicated L0, while the logical space of the second storage layer 41 is indicated L1. FIG. 3 is a diagram schematically showing these two logical spaces L0 and L1 as longitudinal strips. First logical space L0 extends from logical address 0 to logical end address N, thus has a capacity of N+1 addresses. The next logical address N+1 is to be found in the second logical space L1, approximately aligned with address N in the case of an OTP disc. The second logical space L1 extends to logical end address M; if the size of the second logical space L1 is equal to the size of the first logical space L0, M=2N+1.

In the first logical space L0, logical address 0 is located closer to the centre of the disc 2, and logical end address N is located closer to the perimeter of the disc 2. In the second logical space L1, in the case of an OTP disc, the first logical address N+1 is located closer to the perimeter of the disc 2, substantially aligned with logical end address N of L0, and the logical end address M is located closer to the centre of the disc 2. When information is recorded, the disc drive starts at logical address 0, following the first logical space L0 from the centre to the perimeter, as indicated by arrow 51. After writing in the end address N, a transition is made to the second logical space L1, as indicated by arrow 52, and then the second logical space L1 is followed from the perimeter to the centre, as indicated by arrow 53.

FIG. 4 is a diagram comparable to FIG. 3, showing the transition of the two storage spaces L0 and L1 at a larger scale than FIG. 3, and also showing schematically a video sequence 30, for instance corresponding to a movie, also illustrated as a strip. As a difference with respect to FIG. 3, the two storage spaces L0 and L1 are depicted next to each other, the start of L1 (address N+1) adjacent to the end of L0 (address N). For sake of convenience, the start of L0 and the end of L1 are not shown.

The host 20 has an input 21 for receiving the video from a video source (FIG. 1), which may be any suitable source, for instance a TV tuner. The host 20 organizes the video data to form cells 35; cell boundaries between the video cells 35 are indicated at 34. Specifically, a cell boundary is the boundary between the last address of the previous cell and the first address of the next cell. With respect to “video cells”, reference is made to part III of the DVD video specification.

In the following, individual cells are distinguished by adding an index between square brackets. Likewise, individual cell boundaries are distinguished by adding an index between square brackets. The index x of a cell boundary 34[x] corresponds to the index of the cell 35[x] immediately before that cell boundary 34[x]. Further, each cell 35[x] has a length L[x]. Normally, the cells will have equal lengths, but this is not essential; by way of illustrative example, the following will assume that all lengths are equal to a standard length Ls. As will be known to persons skilled in the art, each cell 35[x] contains information (in NAVPACKS) indicating the length L[x] of that cell as well as a pointer to the logical address A[x] of the end of that cell; this information is schematically indicated in FIG. 4 as INFO[x].

Assume that a data storage system not implemented in accordance to the present invention is to store the video sequence 30. The host device 20 transfers the video sequence 30 to the disc drive 10 over host/drive communication link 5, and the disc drive 10 writes the video sequence 30 to disc 2 over drive/disc communication link 6, wherein the start of the video sequence 30 is written at a block in L0 having a certain logical address which may be determined by the host device 20, or which may be the first available block after a previous recording. As writing continues, the logical addresses increase. FIG. 4 illustrates the write process approaching the end of the first storage space L0. The host 20 has written a complete previous video cell 35[i-1] having end address A[i-1], and has started processing the current cell 35[i]. If the host 20 receives sufficient video data at its input 21, the current video cell 35[i] will extend from address A[i-1]+1 to cell end address A[i]=A[i-1]+Ls. If the remaining space R in the first storage space L0 is smaller than the standard cell length Ls, the cell end address A[i] of the current cell 35[i] is located in the second storage space L1. If address N is reached, the disc drive 10 makes a transition to the first available block in the next storage layer L1, having logical address N+1. It can be seen in FIG. 4 that this transition corresponds to a location somewhere within the video cell 35[i], which is undesirable.

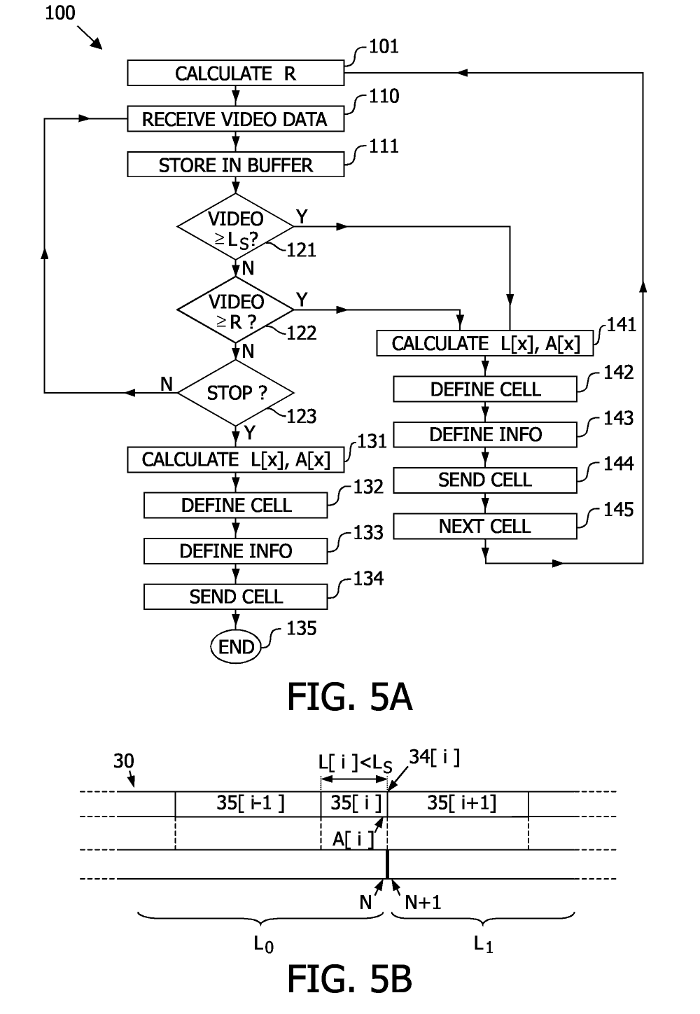

FIG. 5A is a flow schedule showing steps of a recording method 100 performed by a data storage system implemented in accordance to the present invention, and FIG. 5B is a diagram, comparable to FIG. 4, illustrating the operation of this data storage system.

In the case of a data storage system implemented in accordance to the present invention, the host 20 is designed, at least at the start of a cell 35 [i], to calculate the size of the remaining space R in L0 [step 101].

It is noted that the host 20 receives video information at its input 21, and also receives user command signals from a user input device 22, for instance a key board, a remote control, etc. The user may input a stop command, or the video source may stop providing video signals. In both cases, the host 20 may generate a cell boundary and then stop the recording, but as long as this does not happen the host does not know how much video there is to be expected. So, although the host knows the standard size Ls of a cell, the host does not know whether or not it will receive sufficient video data to fill the current cell. Consequently, the host does not yet know the length L[x] nor the end address A[x] of the current video cell 35[x], which implies that the host can not yet send the video data to the disc drive 10. Therefore, the host 20 receives video data at its input 21 [step 110], and stores this data in a buffer memory 23 [step 111].

In step 121, the host checks whether the amount of video data received is equal to (or larger than) the predetermined standard cell size Ls. If not, then the host checks in step 122 whether the amount of video data received is equal to (or larger than) the size of the remaining space R in L0. If not, and if the host also has not received a stop command [step 123], the host returns to step 110 for further receiving video data.

If a stop command is received before reaching end address N of L0, the host calculates [step 131] the length L[x] and the end address A[x] of the current video cell 35 [x] on the basis of the amount of video data received and stored in buffer memory 23, organizes the video data as a cell [step 132], defines (as known per se) the information INFO[x] regarding the length L[x] and the end address A[x] of the current video cell 35[x] and incorporates this information INFO[x] in the video data [step 133], sends the current cell 35[x] to the disc drive [step 134], and ends the recording process [step 135].

It is noted that if the video input stream is interrupted, the host may stop recording and branch to step 131, but this is not shown in FIG. 5A.

If in step 121 the host finds that it has received an amount of video data corresponding to the predetermined size Ls of a video cell, the host decides that it can now write the cell to the disc 2. Thus, the host jumps to step 141 to calculate the length L[x] of this video cell, and calculates the end address A[x] of the current video cell. The video data is organised as a cell [step 142], the information INFO[x] regarding the length L[x] and the end address A[x] of the current video cell 35[x] is defined (as known per se) and incorporated in the video data [step 143]. Then, the cell is ready to be sent to the disc drive [step 144]. The host is now ready to receive video data for a next video cell [step 145], so the host returns to step 101 and the process described above is repeated.

It is noted that steps 141 to 144 correspond to the steps 131 to 134, and relate to the steps necessary for defining a video cell from a certain amount of video data. Since this is known per se, these steps do not need to be described in more detail here.

The above process is repeated for as long as the host receives video data. The video data is accumulated in the memory 23, until sufficient video data has been received for filling a video cell. Then, a new video cell is generated, and sent to the disc drive for recording to the disc. Only when the end of the first storage space L0 approaches, the host deviates from the above process. This is achieved by step 122. If the amount of video data received and stored in buffer memory 23 does not yet correspond to the predetermined length Ls of a standard video cell, but corresponds to the remaining space R in L0, the host also decides to generate a video cell on the basis of the amount of video data stored in the buffer memory 23, so the host also branches to step 141.

In other words, the host defines a video cell if it considers that the amount of video data corresponds to a predetermined cell length or if it finds that the amount of video data corresponds to the size of the remaining free portion of the first storage space. The result is illustrated in FIG. 5B. A video cell 35[i] having a length L[i] smaller than the standard cell size Ls is written at the extreme end of the first storage space L0 such that the end address A[i] corresponds to the end address N of the first storage space L0. In other words, the cell boundary 34[i] is aligned with the transition between the first storage space L0 and the second storage space L1.

After this, the host makes a transition to the second storage space L1.

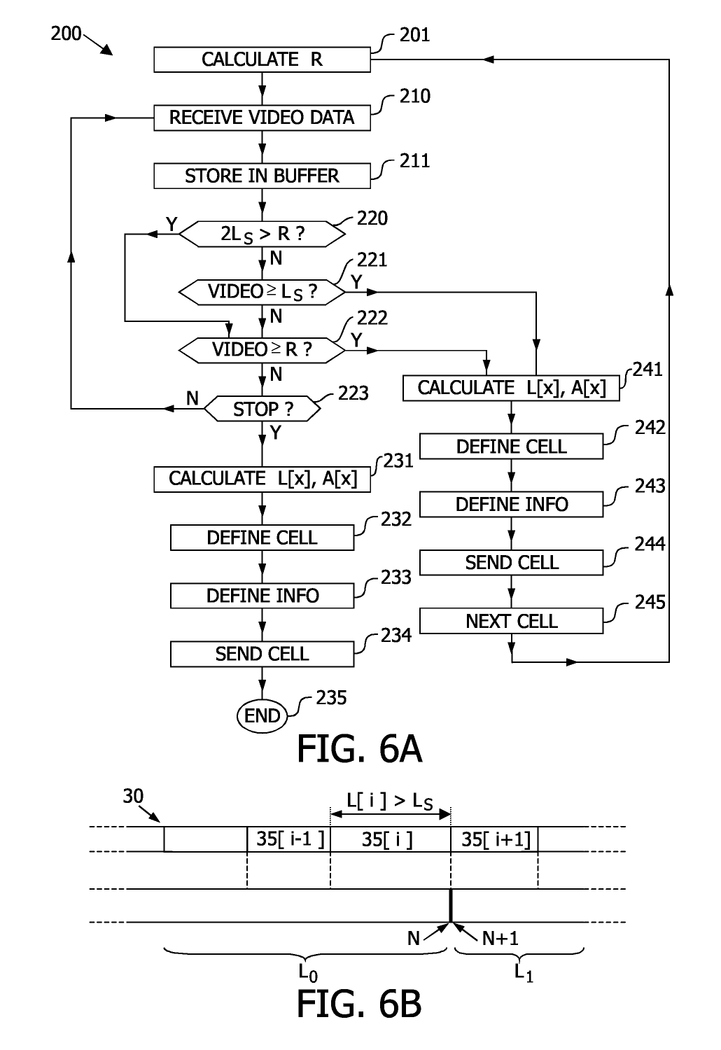

FIGS. 6A and 6B are comparable to FIGS. 5A and 5B, respectively, and illustrate a recording method 200 which is a variation of the recording method 100 described above with reference to FIG. 5A. In FIG. 6A, all steps are numbered with a reference number in the 200-range, and are equivalent or equal to the steps having the same number yet in the 100-range in FIG. 5A. The only difference is step 220 between steps 211 and 221. In step 220, the host checks whether the size of the remaining space R in L0 is smaller than two times the predetermined standard cell size Ls. If this is not the case, i.e. if the remaining size is sufficiently large, the recording process proceeds as usual to step 221, and video cells are written in the same way as described with reference to FIG. 5A and FIG. 5B.

If in step 220 it is found that the size of the remaining space R in L0 is insufficient for recording two complete video cells having standard cell size Ls, the host decides to write one larger video cell 35[i] having a size L[i] larger than the standard cell size Ls in the remaining space R. To this end, the host bypasses step 221, i.e. the step where the host checks whether the video data corresponds to a standard cell, and jumps directly to step 222, where the host checks whether the amount of video data received corresponds to the size of the remaining space R. Thus, if the user does not issue a stop command earlier (step 223), the host continues collecting video data until it has sufficient data to fill the entire remaining space R, and then it jumps to step 241 for completing the cell and writing the cell.

When comparing this second recording method 200 with the first recording method 100, the main difference is that the number of video cells written by the second method 200 is one less than the number of cells written by the first method 100. When looking at FIG. 5B, the two cells 35[i-1] and 35[i] written by the first method 100 would have been written together as one larger video cell when written by the second method 200.

The first method 100 allows a video cell 35[i] with a relatively small size to be written at the end of the first storage space L0. This is prevented by the second method 200. When the factor 2 in step 220 is used, the second method 200 prevents video cells having a size smaller than the standard size Ls to be written at the end of the storage space L0. However, this factor may also be chosen smaller. For instance if this factor is replaced by a factor 1.9, the method allows video cells having a size in the range between 0.9•Ls and 1.0•Ls but prevents cells having a size smaller than 0.9•Ls. Thus, depending on design considerations, the factor 2 may be replaced by a factor α selected in the range from 1.0 to 2.0.

It is noted that in both cases, in the first method 100 as well as in the second method 200, it is assumed that the host 20 attempts to make all video cells having the same size Ls. However, this is not essential; for instance, it may be that the standard size Ls changes as a function of the radius of the storage space. It is only essential that the host 20 has two considerations for deciding the length of the current video cell, one consideration relating to the available space in the first storage space (steps 122 and 222), and another consideration which is independent of the remaining size of the current storage space (steps 121 and 221).

It is noted that the above example relates to the transition from the first storage space L0 to the second storage space L1. Similar considerations would play a roll when a disc has three or more storage layers, and a transition is to be made from the second storage space L1 to a third storage space L2, or from the third storage space L2 to a fourth storage space L3, etc.

It should be clear to a person skilled in the art that the present invention is not limited to the exemplary embodiments discussed above, but that several variations and modifications are possible within the protective scope of the invention as defined in the appending claims.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for recording information on a multi-layered optical disc (2), the disc comprising at least a first storage space (L0) and a second storage space (L1) in adjacent storage layers (40, 41), each storage space comprising storage locations with storage addresses;
wherein data to be recorded are received from a source;
wherein, on recording, the data are organized to form cells (35), each cell corresponding to a certain amount of data;
wherein the cells are first recorded in the first storage space (L0) until the last storage address (N) of the first storage space (L0), and then the recording process makes a transition to the first storage address (N+1) of the second storage space (L1);
wherein the size of the last cell to be recorded in the first storage space (L0) is determined in relationship to the size of the remainder part (R) of the first storage space (L0) available for recording, such that the transition from the first storage space (L0) to the second storage space (L1) corresponds to a cell boundary (34).

2. Method according to claim 1, wherein a target cell size (Ls) is determined;
wherein the received data to be recorded are stored in a buffer memory (23);
wherein the amount of data stored in the buffer memory (23) is monitored;
wherein the size of the remainder part (R) of the first storage space (L0) available for recording is calculated;
and wherein, if the size of the remainder part (R) of the first storage space (L0) is at least equal to the target cell size (Ls), the data received and stored in the buffer memory (23) is organized to define a cell and this cell is recorded in the first storage space (L0) when the amount of said data stored in said buffer memory (23) is at least equal to the target cell size (Ls).

3. Method according to claim 1, wherein a target cell size (Ls) is determined;
wherein the received data to be recorded are stored in a buffer memory (23);
wherein the amount of data stored in the buffer memory (23) is monitored;
wherein the size of the remainder part (R) of the first storage space (L0) available for recording is calculated;
and wherein, if the size of the remainder part (R) of the first storage space (L0) is smaller than the target cell size (Ls), the data received and stored in the buffer memory (23) is organized to define a cell and this cell is recorded in the first storage space (L0) when the amount of said data stored in said buffer memory (23) is equal to the size of the said remainder part (R).

4. Method according to claim 1, wherein a target cell size (Ls) is determined;
wherein the received data to be recorded are stored in a buffer memory (23);
wherein the amount of data stored in the buffer memory (23) is monitored;
wherein the size of the remainder part (R) of the first storage space (L0) available for recording is calculated;
and wherein, if the size of the remainder part (R) of the first storage space (L0) is larger than the target cell size (Ls) but smaller than x times the target cell size (Ls), the data received and stored in the buffer memory (23) is organized to define a cell and this cell is recorded in the first storage space (L0) when the amount of said data stored in said buffer memory (23) is equal to the size of the said remainder part (R).

5. Method according to claim 4, wherein the factor x is approximately equal to 2.

6. Method according to claim 1, wherein the target cell size (Ls) is a predefined value that is the same for all cells.

7. Host device (20), capable of cooperating with an optical disc drive (10), the host device (20) being designed to execute the method according to claim 1.

8. Host device according to claim 7, comprising an input (21) for receiving data and a buffer memory (23) for storing received data before sending the data to the disc drive (10) for recording.

9. Host device according to claim 8, wherein the buffer memory (23) has a buffer capacity at least equal to a predetermined target cell size (Ls), preferably at least equal to two times the predetermined target cell size (Ls).

10. Data storage system (1), comprising an optical disc drive (10) and a host device (20) according to claim 7.
